(19) United States
(12) Patent Application Publication
(10) Pub. No.: US 2019/0236812 A1
(43) Pub. Date: Aug. 1, 2019

(54) Digital Color Transformation Method

(71) Applicant: George Beck, Toronto (CA)

(72) Inventor: George Beck, Toronto (CA)

(21) Appl. No.: 16/246,586

(22) Filed: Jan. 14, 2019

Related U.S. Application Data
(60) Provisional application No. 62/617,627, filed on Jan. 16, 2018.

(51) Int. Cl. G06T 11/00; G06T 7/90

(52) U.S. Cl. CPC G06T 11/001; G06T 7/90

(57) ABSTRACT

A technique for modifying a digital representation of a color, based on a given color palette.

### BACKGROUND OF THE INVENTION

The present invention is in the technical field of color transformation in digital devices. More particularly, the present invention is in the technical field of converting a given digital representation of one color to another color in the context of a given color palette.

### SUMMARY OF THE INVENTION

The present invention is a method of converting a given digital representation of a color, to a digital representation of a new color with properties derived from given reference color palette.

### BRIEF DESCRIPTION OF THE DRAWING

FIG. 1 is flow chart depicting the implementation of the digital color transformation method according to the embodiment of the current invention;

### DETAILED DESCRIPTION OF THE INVENTION

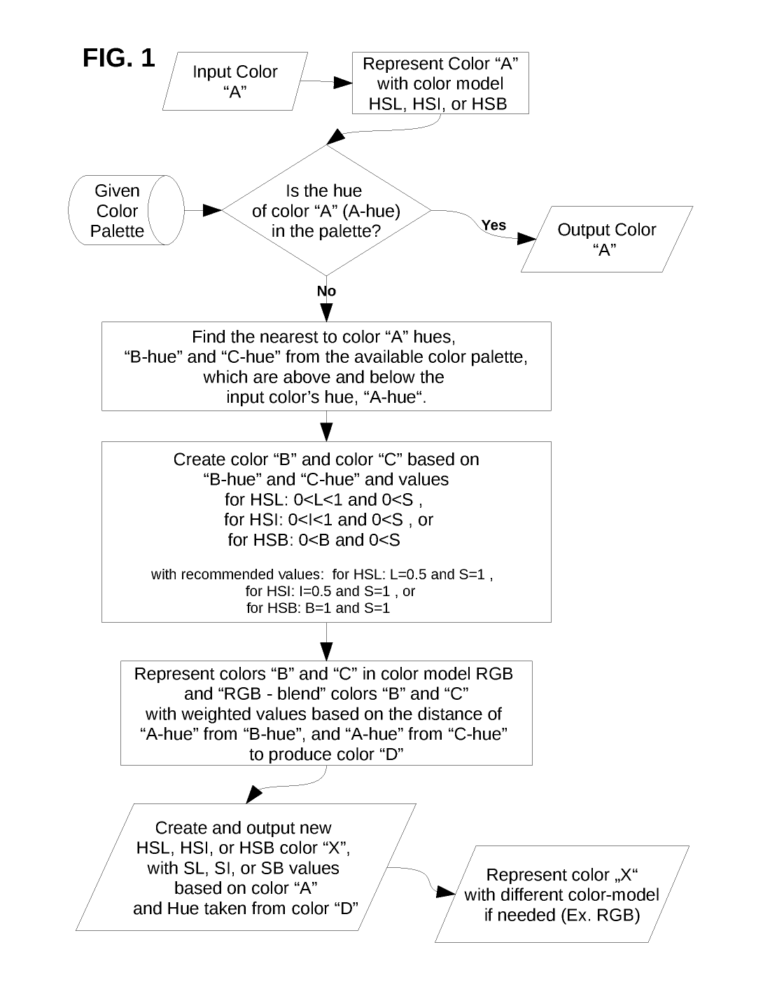

Referring now to the invention in more detail, in FIG. 1; There is shown the method of transforming a given digital representation of a color, to digital representation of a new color with properties derived from given reference color palette.

The input color will be referred to as color “A”. Color “A” is represented with, or converted to color model describing it with, HSL—hue, saturation, and lightness (or luminosity), HSI—hue, saturation, and intensity, or HSB—hue, saturation, and brightness (HSB is also often called HSV, V for “value”). Color “A”'s hue will be referred to as “A-hue”. “A-hue” is checked if it is present in the given color palette, and if it is found in the given palette, color “A” is given as output.

If “A-hue” is not present in the palette, the nearest available hues below and above the value of “A-hue” are taken from the palette. Those values will be referred as “B-hue” and “C-hue”. Based on the values of “B-hue” and “C-hue” new colors are created, which will be referred to as color “B” and color “C”, and will have:
values for “saturation” bigger than zero (for HSL, HSI, and HSV),
values for “luminosity” bigger than zero, and smaller than one for HSL, or values for “intensity” bigger than zero, and smaller than one for HSI, or values for “brightness” bigger than zero (for HSB).
   Recommended values are L=0.5 and S=1 for HSL, 1=0.5 and S=1 for HSI, or B=1 and S=1 for HSB. Colors “B” and “C”, will be represented in RGB color model, and blended as weighted RGB values, with weights based on the distance of “A-hue” to “B-hue”, and “A-hue” to “C-hue”, to produce new color, which will be referred here as color “D”. Color “D”=weight_b*RGB(“B”)+weight_c*RGB(“C”), where:

“weight_b”=absolute value of (1−(“A-hue”−“B-hue”)/(“C-hue”−“B-hue”)), and “weight_c”=1−“weight_b

The new color, which will be created for output, will be with hue value equal to hue value of color “D”, and depending on the desired output color model (HSL, HSI, or HSV), SL (saturation and luminosity), SI (saturation and intensity), or SB (saturation and brightness) values based on the input color “A”.

What is claimed is:

1. A method of converting a given digital representation of a color, to a digital representation of a new color with properties derived from given reference color palette, comprising the steps of:
representing the given color with color model HSL, HSI or HSB;
determining if the given color has the same hue-value of a color in the given reference color palette;
if the given color's hue-value is the same as the hue-value of a color present in the reference color palette, outputting the given color, otherwise continuing to the next step;
determining two colors from the given reference color palette with closest hue-values, one smaller and one larger, to the given color's hue-value;
creating two new colors based on the found two colors, with color model HSL, HSI or HSB, using the hue-values of the found colors and values for HSL: 0<L<1 and 0<S, for HSI: 0<I<1 and 0<S, or for HSB: 0<B and 0<S, with recommended values for HSL: L=0.5 and S=1, for HSI: 1=0.5 and S=1, or for HSB: B=1 and S=1;
representing the two created (in the previous step), colors in RGB color mode;
blending the two created colors, represented in RGB color mode, with weighted values depending on the difference to the given color's hue-value;
creating a new color, based on the initially given color, with new hue-value taken from the result of the blended colors from the previous step;
representing the new color in a desired color model;
outputting the created new color.
